(19) United States
(12) Patent Application Publication
(10) Pub. No.: US 2007/0222610 A1
(43) Pub. Date: Sep. 27, 2007

(54) RFID tag

(75) Inventor: Hiroki Tagato, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/723,876

(22) Filed: Mar. 22, 2007

(30) Foreign Application Priority Data
Mar. 23, 2006 (JP) 080490/2006

(51) Int. Cl. G08B 13/14

(52) U.S. Cl. 340/572.7; 340/572.8

(57) ABSTRACT

An RFID tag includes an external power input unit, first antenna unit, first power supply unit, memory unit, and control unit. The external power input unit inputs external power. The first antenna unit receives power from a communication device. The first power supply unit extracts power from the radio wave received by the first antenna unit. The control unit operates upon receiving power from the first power supply unit and controls permission and inhibition of access from the communication device to the memory unit in accordance with presence/absence of input of power from the external power input unit.

### BACKGROUND OF THE INVENTION

The present invention relates to an RFID (Radio Frequency Identification) tag which performs data communication with a communication device such as a reader or a reader/writer through radio waves.

Recently, RFID has rapidly become popular as an automatic identification technique using radio communication. A general RFID system comprises an RFID tag, which is attached to an article to identify it, and a reader/writer (RFID reader/writer), which is used to read out data stored in a memory in the RFID tag or write data in the memory in the RFID tag.

One of the features of RFID technique is contactless access to tag memory. This feature makes it possible to read/write data from/in tag memory even when multiple articles, each of which is attached an RFID tag, are packed in a box without unpacking it. This technique can improve the efficiency of various business processes such as article receiving and shipping, and hence is expected to be applied to various supply chain processes.

RFID technique using UHF (Ultra High Frequency) band allows access to tag memory from a longer distance than using microwave band or HF (High Frequency) band. With this feature, higher expectations have been placed on using UHF band.

Since RFID technique allows contactless access to tag memory, it is possible that a malicious user reads/rewrites data from/in the RFID tag without letting the owner or authorized user of the RFID tag consent to or notice it. This may pose serious problems in terms of privacy protection and information security.

Since RFID using UHF band allows access to memory of an RFID tag even if an RFID reader/writer is considerably distant from the RFID tag, it is difficult for the owner to notice unauthorized access, posing a serious problem.

In order to cope with such a problem, for example, reference 1 (G. Karjoth and P. Moskowitz, “Disabling RFID tags with Visible Confirmation: Clipped Tags Are Silenced”, In Proceedings of Workshop on Privacy in the Electronic Society, November 2005.) discloses an RFID tag which prevents unwanted access by physically removing some part of an antenna of the RFID tag so as to disable access to the memory from a long distance.

The method disclosed in reference 1, however, physically breaks part of an RFID tag, and hence it is difficult to restore the tag to its initial unbroken state afterward. In addition, assume that the memory of an RFID tag stores both data to be protected against unauthorized access and data which does not require such protection. In this case, this technique disables access from long distance to the data which does not require protection. This may degrade convenience in using RFID.

### SUMMARY OF THE INVENTION

The present invention has been made to solve this problem, and has as its objective to provide an RFID tag which can prevent unauthorized access from a long distance without physically removing part of an antenna.

It is another objective of the present invention to provide an RFID tag with high convenience which can prevent unauthorized access from a long distance without physically removing part of an antenna, properly protects only data requiring protection against long-distance unauthorized access, and allows long-distance access to data which requires no protection.

In order to achieve the above objectives, according to the present invention, there is provided an RFID tag comprising an external power input unit which inputs external power, a first antenna unit which receives power from a communication device, a first power supply unit which extracts power from the radio wave received by the first antenna unit, a memory unit, and a control unit which operates upon receiving power from the first power supply unit and controls permission and inhibition of access from the communication device to the memory unit in accordance with presence/absence of input of power from the external power input unit.

### BRIEF DESCRIPTION OF THE DRAWINGS

FIG. 1 is a block diagram showing the schematic arrangement of an RFID tag according to the first embodiment of the present invention;

FIG. 2 is a block diagram showing the arrangement of the control unit of the RFID tag according to the first embodiment;

FIG. 3 is a flowchart for explaining the access inhibition/permission function of the control unit of the RFID tag according to the first embodiment;

FIG. 4 is a view for explaining the operation of the RFID tag in a case wherein an RFID reader/writer is located at a long distance from the RFID tag;

FIG. 5 is a view for explaining the operation of the RFID tag in a case wherein the RFID reader/writer is located at a short distance from the RFID tag;

FIG. 6 is a block diagram showing the second embodiment as a modification of the first embodiment;

FIG. 7 is a view showing how an RFID tag according to the second embodiment is used;

FIG. 8 is a block diagram showing the schematic arrangement of an RFID tag according to the third embodiment of the present invention;

FIG. 9 is a block diagram showing the arrangement of the control unit of the RFID tag according to the third embodiment;

FIG. 10 is a flowchart for explaining the access inhibition/permission function of the control unit of the RFID tag according to the third embodiment;

FIG. 11 is a view for explaining the operation of the RFID tag in a case wherein an RFID reader/writer is located at a long distance from the RFID tag;

FIG. 12 is a view for explaining the operation of the RFID tag in a case wherein the RFID reader/writer is located at a short distance from the RFID tag;

FIG. 13 is a block diagram showing the fourth embodiment as a modification of the third embodiment;

FIG. 14 is a block diagram showing the schematic arrangement of an RFID tag according to the fifth embodiment of the present invention;

FIG. 15 is a view showing the relationship between the respective addresses in a data memory unit and the flag values in a flag memory unit in an RFID tag according to the fifth embodiment;

FIG. 16 is a block diagram showing the arrangement of the control unit of the RFID tag according to the fifth embodiment;

FIG. 17 is a flowchart for explaining the access inhibition/permission function of the control unit of the RFID according to the fifth embodiment;

FIG. 18 is a view for explaining the operation of the RFID tag in a case wherein an RFID reader/writer is located at a long distance from the RFID tag;

FIG. 19 is a view for explaining the operation of the RFID tag in a case wherein the RFID reader/writer is located at a short distance from the RFID tag;

FIG. 20 is a block diagram showing the sixth embodiment as a modification of the fifth embodiment;

FIG. 21 is a block diagram showing the schematic arrangement of an RFID tag according to the seventh embodiment of the present invention;

FIG. 22 is a block diagram showing the arrangement of a control unit for the RFID tag according to the seventh embodiment;

FIG. 23 is a flowchart for explaining the access inhibition/permission function of the control unit according to the seventh embodiment;

FIG. 24 is a view for explaining the operation of an RFID tag in a case wherein an RFID reader/writer is located at a long distance from the RFID tag;

FIG. 25 is a view for explaining the operation of the RFID tag in a case wherein the RFID reader/writer is located at a short distance from the RFID tag;

FIG. 26 is a block diagram showing the eighth embodiment as a modification of the seventh embodiment;

FIG. 27 is a view showing how an RFID tag according to the eighth embodiment is used;

FIG. 28 is a block diagram showing the schematic arrangement of an RFID tag according to the ninth embodiment of the present invention; and

FIG. 29 is a view showing how the RFID tag according to the ninth embodiment is used.

### DESCRIPTION OF THE PREFERRED EMBODIMENTS

The present invention will be described in detail below with reference to the accompanying drawings.

### First Embodiment

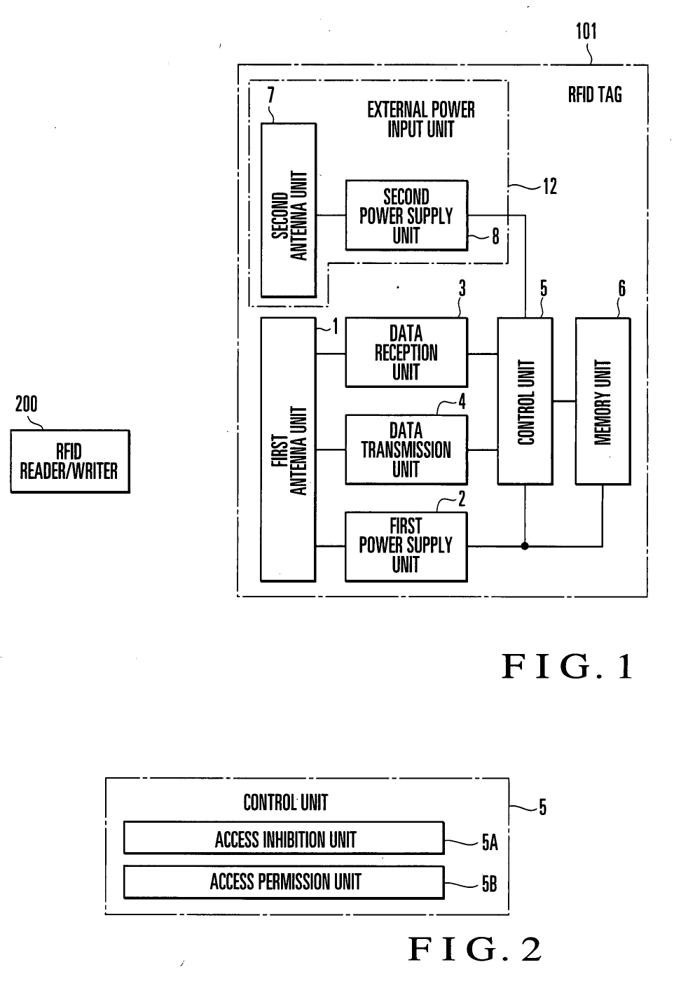

FIG. 1 shows the schematic arrangement of an RFID tag according to the first embodiment of the present invention. As shown in FIG. 1, an RFID tag 101 according to the first embodiment comprises a first antenna unit 1 which transmits/receives radio waves to/from an RFID reader/writer 200, a first power supply unit 2 which extracts power from the radio wave received by the first antenna unit 1, a data reception unit 3 which decodes a command contained in the radio wave received by the first antenna unit 1 and transmits the resultant data to a control unit 5, a data transmission unit 4 which encodes the return data transmitted from the control unit 5 in a transmission radio wave from the first antenna unit 1, the control unit 5 which interprets the command contained in the radio wave received by the first antenna unit 1 and accesses a memory unit 6, the memory unit 6 which stores an ID, user data, and the like and an external power input unit 12 which inputs external power. The external power input unit 12 comprises a second antenna unit 7 having lower radio wave reception sensitivity than the first antenna unit 1, and a second power supply unit 8 which extracts power from the radio wave received by the second antenna unit 7.

In the RFID tag 101, the first antenna unit 1 and the second antenna unit 7 use the same frequency band for communication. Letting L1 be the communicable distance of the first antenna unit 1, and L2 be the communicable distance of radio waves from the second antenna unit 7, the size of the second antenna unit 7 is set to be sufficiently smaller than that of the first antenna unit 1 so as to set the communicable distance L1 of the first antenna unit 1 to a long distance and set the communicable distance L2 of radio waves from the second antenna unit 7 to a short distance.

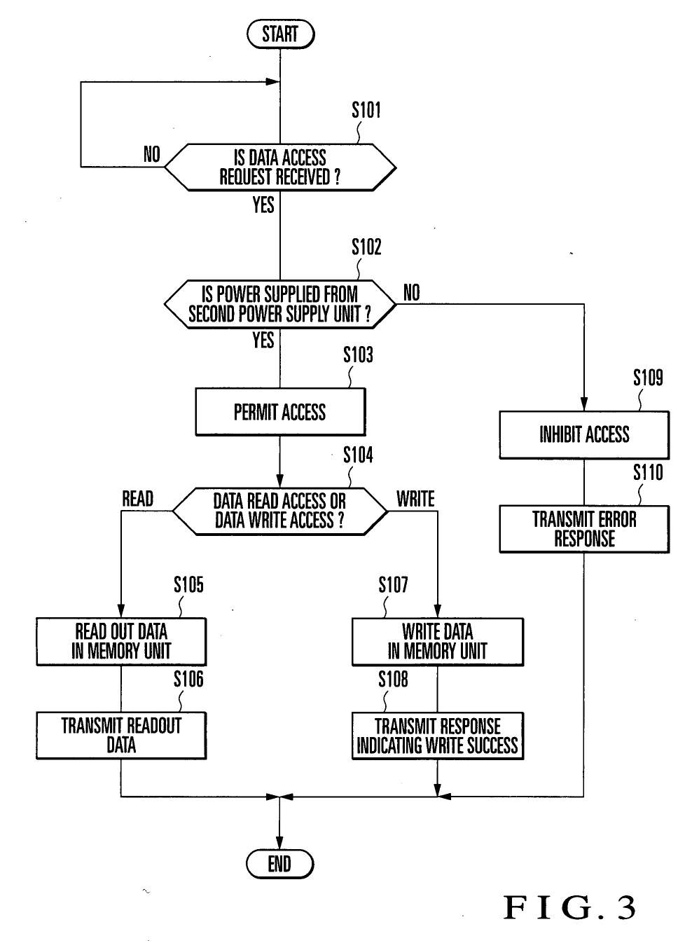

In the RFID tag 101, the control unit 5 operates upon receiving power from the first power supply unit 2. The control unit 5 has, as a function unique to this embodiment, an access inhibition/permission function of inhibiting and permitting access to the memory unit 6 on the basis of whether power (external power) is input from the second power supply unit 8. More specifically, as shown in FIG. 2, the control unit 5 has two functional units, i.e., an access inhibition unit 5A which inhibits access from the RFID reader/writer 200 to the memory unit 6 through the first antenna unit 1 if no power is received from the second power supply unit 8, and an access permission unit 5B which permits access from the RFID reader/writer 200 to the memory unit 6 through the first antenna unit 1 if power is received from the second power supply unit 8. The access inhibition/permission function of the control unit 5 will be described with reference to the flowchart shown in FIG. 3.

### [When RFID Reader/Writer is Located at Long Distance]

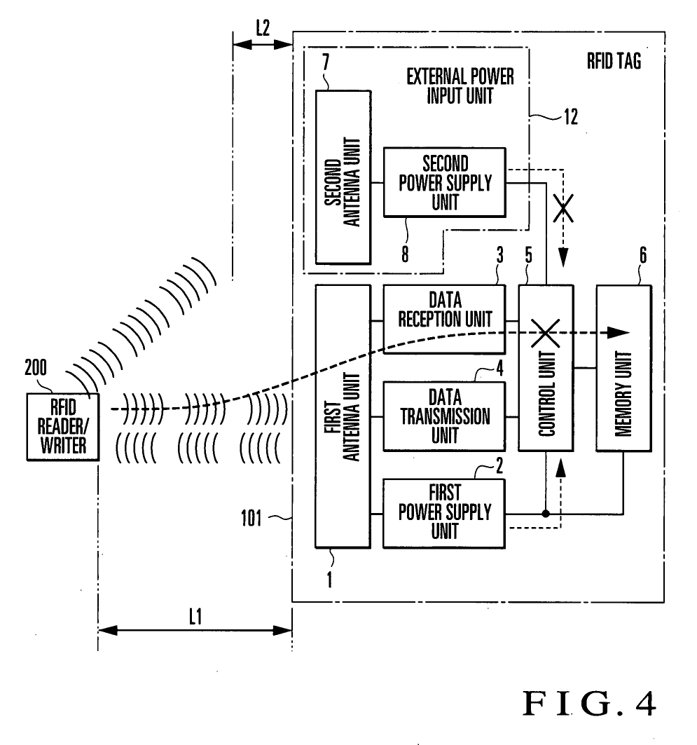

Assume that as shown in FIG. 4, the RFID reader/writer 200 is located at along distance (between L1 and L2). In this case, the first antenna unit 1 of the RFID tag 101 receives a radio wave from the RFID reader/writer 200, and the first power supply unit 2 supplies power extracted from the radio wave received by the first antenna unit 1 to the control unit 5. The control unit 5 operates upon receiving the power from the first power supply unit 2, and checks whether the command contained in the radio wave received by the first antenna unit 1 is a data access request (step S101).

If the command from the RFID reader/writer 200 is an access request (YES in step S101), the control unit 5 checks whether power is supplied from the second power supply unit 8 (step S102). If no power is supplied from the second power supply unit 8 (NO in step S102), the process advances to step S109. If power is supplied from the second power supply unit 8 (YES in step S102), the process advances to step S103.

In this case, since the RFID reader/writer 200 is located between L1 and L2, the power of radio waves from the RFID reader/writer 200 is not sufficient for the reception sensitivity of the second antenna unit 7. The second power supply unit 8 cannot therefore extract power, and supplies no power to the control unit 5. For this reason, in accordance with NO in step S102, the control unit 5 advances to step S109 to inhibit access to the memory unit 6 which is based on the data access request received in step S101 and transmit an error response to the RFID reader/writer 200 through the data transmission unit 4 (step S110).

In this case, the RFID reader/writer 200 may not be an authorized communication device but may be a malicious communication device. The first embodiment inhibits access from the RFID reader/writer 200 at a long distance to the memory unit 6 in the RFID tag 101 regardless of whether the RFID reader/writer 200 is an authorized communication device. This prevents malicious access from a long distance.

### [When RFID Reader/Writer is Located at Short Distance]

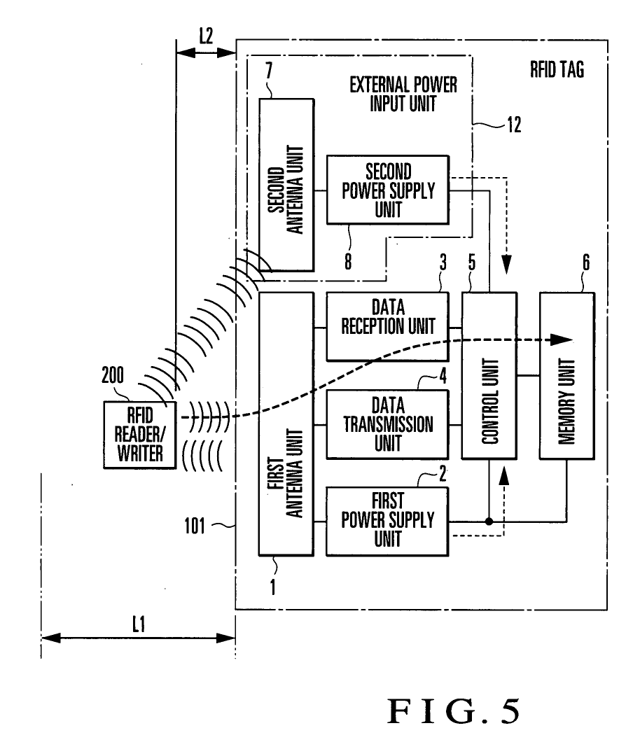

Assume that as shown in FIG. 5, the RFID reader/writer 200 is located at a short distance (within L2). In this case, the power of radio waves from the RFID reader/writer 200 is sufficiently high for the reception sensitivity of the second antenna unit 7 of the RFID tag 101. This makes the first power supply unit 2 extract power from the radio wave received by the first antenna unit 1, and makes the second power supply unit 8 extract power from the radio wave received by the second antenna unit 7. The first and second power supply units then send the extracted power to the control unit 5.

The control unit 5 operates upon receiving the power from the first power supply unit 2, and checks whether the command contained in the radio wave received by the first antenna unit 1 is a data access request (step S101). If the command is a data access request (YES in step S101), the control unit 5 checks whether power is supplied from the second power supply unit 8 (step S102). If no power is supplied from the second power supply unit 8, the process advances to step S109. If power is supplied from the second power supply unit 8, the process advances to step S103.

In this case, since the RFID reader/writer 200 is located within L2, the power of radio waves from the RFID reader/writer 200 is sufficiently high for the reception sensitivity of the second antenna unit 7, and the second power supply unit 8 supplies power to the control unit 5. Therefore, in accordance with YES in step S102, the control unit 5 advances to step S103 to permit access to the memory unit 6 which is based on the data access request received in step S101. The control unit 5 then checks whether the data access request is a data read request or data write request (step S104).

If the data access request is a data read request, the control unit 5 reads out the request data from the memory unit 6 (step S105), and returns the readout data to the RFID reader/writer 200 through the data transmission unit 4 (step S106).

If the data access request is a data write request, the control unit 5 writes the received data in the memory unit 6 (step S107), and returns a response indicating a write success to the RFID reader/writer 200 through the data transmission unit 4 (step S108).

Note that the access inhibition unit 5A of the control unit 5 performs the processing in step S109 if NO in step S102, and the access permission unit 5B performs the processing in step S103 if YES in step S102.

In this case, the RFID reader/writer 200 may not be an authorized communication device but may be a malicious communication device. The first embodiment permits access from the RFID reader/writer 200 at a short distance to the memory unit 6 in the RFID tag 101 regardless of whether the RFID reader/writer 200 is an authorized communication device. Even if some person has made malicious access, since such access must be made from a short distance, the user of the RFID tag can easily visually check the access. This can prevent any person from making malicious access without letting the user of the RFID tag 101 consent to or notice it.

### Second Embodiment

The RFID tag 101 shown in FIG. 1 is configured such that the first antenna unit 1 and the second antenna unit 7 use the same frequency band for communication. However, the frequency band of the first antenna unit 1 may differ from that of the second antenna unit 7, and the RFID tag 101 may include another radio wave source to the second antenna unit 7.

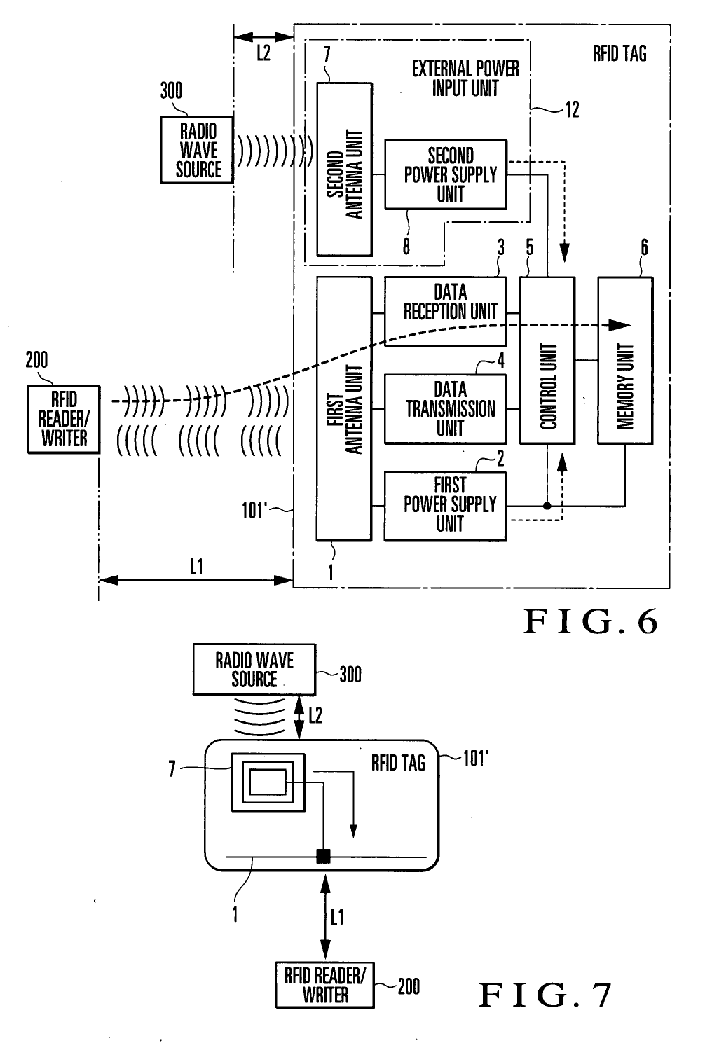

For example, as shown in FIG. 6, the frequency band of a first antenna unit 1 is made to differ from that of a second antenna unit 7, and a radio wave source 300 is provided for the second antenna unit 7 independently of an RFID reader/writer 200.

According to an RFID tag 10′, when the radio wave source 300 is located within a communicable distance L2 of the second antenna unit 7, the second antenna unit 7 receives a radio wave from the radio wave source 300. Since the power of the received radio wave is sufficiently high for the reception sensitivity of the second antenna unit 7, and hence a second power supply unit 8 extracts power from the received radio wave. This makes a control unit 5 permit access from the RFID reader/writer 200 to a memory unit 6.

According to the second embodiment, using the radio wave source 300 allows access from the RFID reader/writer 200 to the memory unit 6 in the RFID tag 101′ regardless of whether the RFID reader/writer 200 is an authorized communication device. Since the radio wave source 300 must be brought close to the RFID tag 101′, the user can easily visually check malicious access. FIG. 7 shows how the user uses the RFID tag 101′.

### Third Embodiment

In the first embodiment, all the data stored in the memory unit 6 are protected from malicious access. However, it is conceivable that some data require no protection depending on the type of data. The third embodiment, therefore, sets only data requiring protection as a target for unauthorized access prevention by switching memory units for storage depending on the type of data, thereby further improving the convenience in using data.

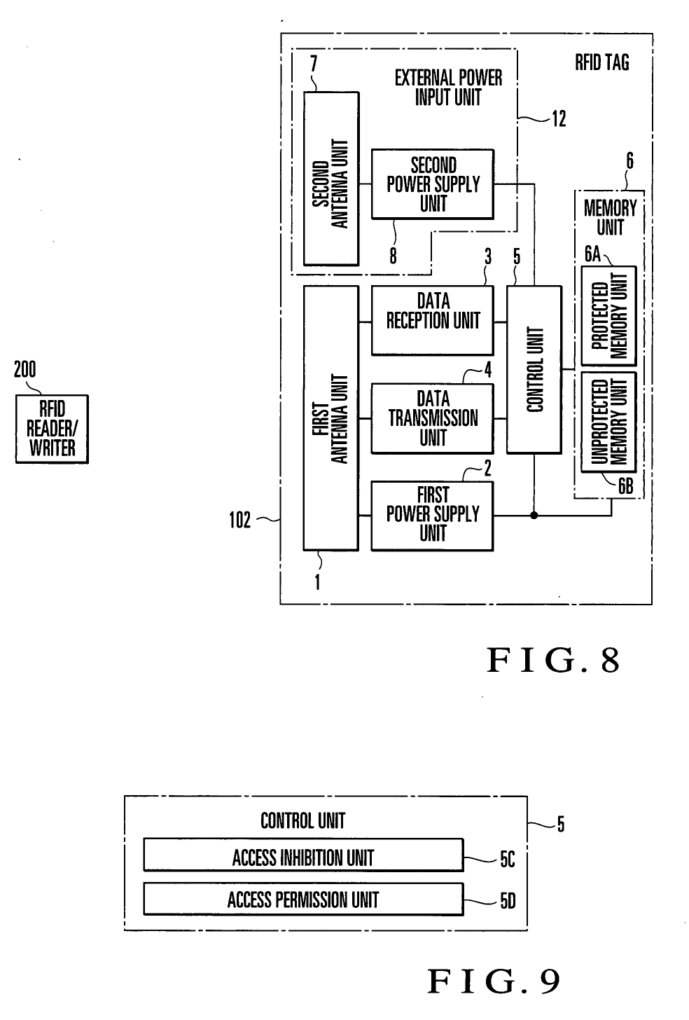

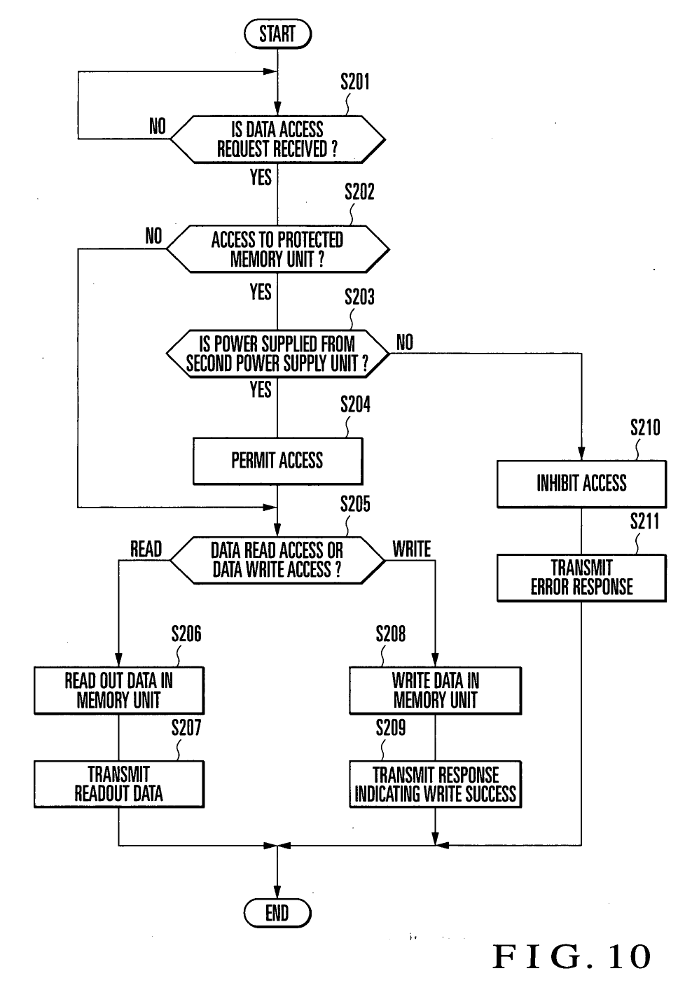

FIG. 8 shows the schematic arrangement of an RFID tag according to the third embodiment of the present invention. An RFID tag 102 of the third embodiment has an arrangement in which a memory unit 6 is divided into a protected memory unit 6A and an unprotected memory unit 6B. The protected memory unit 6A stores data which need protection. The unprotected memory unit 6B stores data which do not need protection. A control unit 5 comprises two functional units, i.e., an access inhibition unit 5C which inhibits access from an RFID reader/writer 200 to the protected memory unit 6A through a first antenna unit 1 if no power is received from a second power supply unit 8, and an access permission unit 5D which permits access from the RFID reader/writer 200 to the protected memory unit 6A through the first antenna unit 1 if power is received from the second power supply unit 8. The access inhibition/permission function of the control unit 5 of the RFID tag 102 according to the third embodiment will be described with reference to the flowchart shown in FIG. 10.

### [When RFID Reader/Writer is Located at Long Distance]

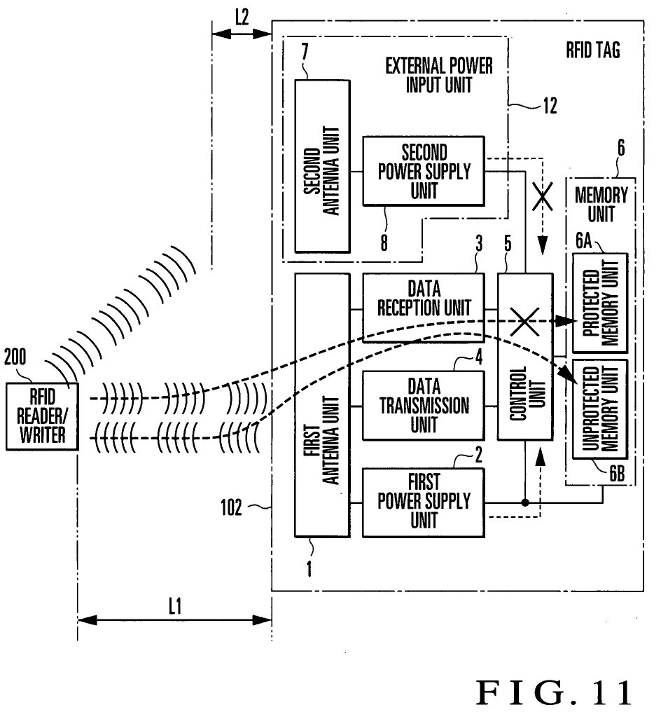

Assume that as shown in FIG. 11, the RFID reader/writer 200 is located at a long distance (between L1 and L2). In this case, the first antenna unit 1 of the RFID tag 102 receives a radio wave from the RFID reader/writer 200, and a first power supply unit 2 supplies power extracted from the radio wave received by the first antenna unit 1 to the control unit 5. The control unit 5 operates upon receiving the power from the first power supply unit 2, and checks whether the command contained in the radio wave received by the first antenna unit 1 is a data access request (step S201).

If the command from the RFID reader/writer 200 is a data access request (YES in step S201), the control unit 5 checks whether the command is an access request to the protected memory unit 6A (step S202). If the command is an access request to the protected memory unit 6A (YES in step S202), the process advances to step S203. If the command is not an access request to the protected memory unit 6A (NO in step S202), the process advances to step S205.

### [If Command is Access Request to Protected Memory Unit]

If the command is an access request to the protected memory unit 6A (YES in step S202), the control unit 5 checks whether power is supplied from the second power supply unit 8 (step S203). If no power is supplied from the second power supply unit 8 (NO in step S203), the process advances to step S210. If power is supplied from the second power supply unit 8 (YES in step S203), the process advances to step S204.

In this case, since the RFID reader/writer 200 is located between L1 and L2, the radio field intensity from the RFID reader/writer 200 is insufficient for the reception sensitivity of a second antenna unit 7. Therefore, the second power supply unit 8 cannot extract power, and hence the second power supply unit 8 sends no power to the control unit 5. In accordance with NO in step S203, the control unit 5 advances to step S210 to inhibit access to the protected memory unit 6A which is based on the data access request received in step S201 and transmit an error response to the RFID reader/writer 200 through a data transmission unit 4 (step S211).

### [If Command is not Access Request to Protected Memory Unit]

If the command is not an access request to the protected memory unit 6A (NO in step S202), the control unit 5 determines that the command is an access request to the unprotected memory unit 6B, and checks whether the access request is a data read request or a data write request (step S205).

If the access request is a data read request, the control unit 5 reads out requested data from the unprotected memory unit 6B (step S206), and returns the readout data to the RFID reader/writer 200 through the data transmission unit 4 (step S207).

If the access request is a data write request, the control unit 5 writes the received data in the unprotected memory unit 6B (step S208), and returns information indicating a write success to the RFID reader/writer 200 through the data transmission unit 4 (step S209).

In this case, the RFID reader/writer 200 may not be an authorized communication device but may be a malicious communication device. The third embodiment permits access from the RFID reader/writer 200 at a long distance to the unprotected memory unit 6B in the RFID tag 102 regardless of whether the RFID reader/writer 200 is an authorized communication device.

However, the embodiment inhibits access to the protected memory unit 6A. This allows access from a long distance to data requiring no protection and can properly protect only data requiring protection against unauthorized access from a long distance.

### [If RFID Reader/Writer is Located at Short Distance]

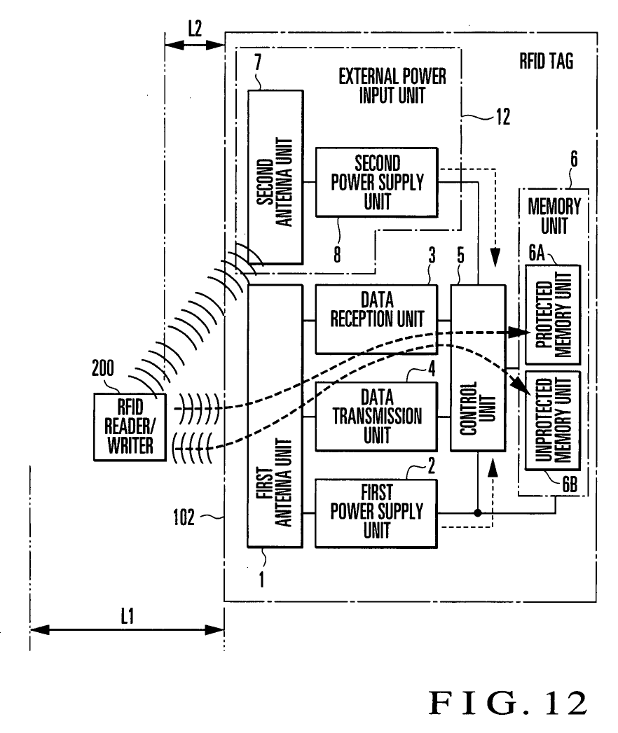

Assume that as shown in FIG. 12, the RFID reader/writer 200 is located at a short distance (within L2). In this case, the power of radio waves from the RFID reader/writer 200 is sufficiently high for the reception sensitivity of the second antenna unit 7 of the RFID tag 102. This makes the first power supply unit 2 extract power from the radio wave received by the first antenna unit 1, and makes the second power supply unit 8 extract power from the radio wave received by the second antenna unit 7. The first and second power supply units then send the extracted power to the control unit 5. The control unit 5 operates upon receiving power from the first power supply unit 2, and checks whether the command contained in the power received by the first antenna unit 1 is a data access request (step S201).

If the command from the RFID reader/writer 200 is a data access request (YES in step S201), the control unit 5 checks whether the command is an access request to the protected memory unit 6A (step S202). If the command is an access request to the protected memory unit 6A (YES in step S202), the process advances to step S203. If the command is not an access request to the protected memory unit 6A (NO in step S202), the process advances to step S205.

### [If Command is Access Request to Protected Memory Unit]

If the command is an access request to the protected memory unit 6A (YES in step S202), the control unit 5 checks whether power is supplied from the second power supply unit 8 (step S203). If no power is supplied from the second power supply unit 8 (NO in step S203), the process advances to step S210. If power is supplied from the second power supply unit 8 (YES in step S203), the process advances to step S204. In this case, since the RFID reader/writer 200 is located within L2, the power of radio waves from the RFID reader/writer 200 is sufficiently high for the reception sensitivity of the second antenna unit 7, and the second power supply unit 8 supplies power to the control unit 5. Therefore, in accordance with YES in step S203, the control unit 5 advances to step S204 to permit access to the protected memory unit 6A which is based on the data access request received in step S201. The control unit 5 then checks whether the data access request to the protected memory unit 6A is a data read request or data write request (step S205).

If the data access request is a data read request, the control unit 5 reads out the request data from the protected memory unit 6A (step S206), and returns the readout data to the RFID reader/writer 200 through the data transmission unit 4 (step S207).

If the data access request is a data write request, the control unit 5 writes the received data in the protected memory unit 6A (step S208), and returns a response indicating a write success to the RFID reader/writer 200 through the data transmission unit 4 (step S209).

Note that the access inhibition unit 5C of the control unit 5 performs the processing in step S210 if NO in step S203, and the access permission unit 5D performs the processing in step S204 if YES in step S203.

In this case, the RFID reader/writer 200 may not be an authorized communication device but may be a malicious communication device. The third embodiment permits access from the RFID reader/writer 200 at a short distance to the protected memory unit 6A in the RFID tag 102 regardless of whether the RFID reader/writer 200 is an authorized communication device. Even if some person has made malicious access, since such access must be made from a short distance, the user of an RFID tag can easily visually check the access. This can prevent any person from making malicious access without letting the user of the RFID tag 102 consent to or notice it.

### Fourth Embodiment

The RFID tag 102 shown in FIG. 8 is configured such that the first antenna unit 1 and the second antenna unit 7 use the same frequency band for communication. However, the frequency band of the first antenna unit 1 may differ from that of the second antenna unit 7, and the RFID tag 102 may include another radio wave source to the second antenna unit 7.

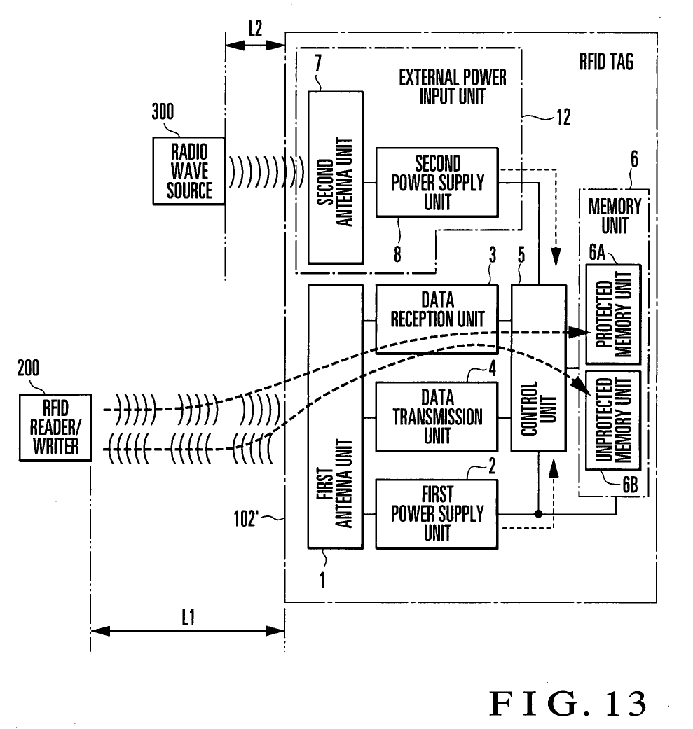

For example, as shown in FIG. 13, the frequency band of a first antenna unit 1 is made to differ from that of a second antenna unit 7, and a radio wave source 300 is provided for the second antenna unit 7 independently of an RFID reader/writer 200.

According to an RFID tag 102′, when the radio wave source 300 is located within a communicable distance L2 of the second antenna unit 7, the second antenna unit 7 receives a radio wave from the radio wave source 300. Since the radio field intensity of the received radio wave is sufficiently high for the reception sensitivity of the second antenna unit 7, and hence a second power supply unit 8 extracts power from the received radio wave. This makes a control unit 5 permit access from the RFID reader/writer 200 to a protected memory unit 6A.

According to the fourth embodiment, using the radio wave source 300 allows access from the RFID reader/writer 200 to the protected memory unit 6A in the RFID tag 102′ regardless of whether the RFID reader/writer 200 is an authorized communication device. Since the radio wave source 300 must be brought close to the RFID tag 102′, the user can easily visually check malicious access.

### Fifth Embodiment

In the first embodiment, all the data stored in the memory unit 6 are protection targets. However, it is conceivable that some data requires no protection depending on the type of data. The fifth embodiment, therefore, sets only data requiring protection as a target for unauthorized access prevention by designating permission/inhibition of data read access and data write access to corresponding addresses in the data memory unit by using flag values in a flag memory unit, thereby further improving the convenience in using data.

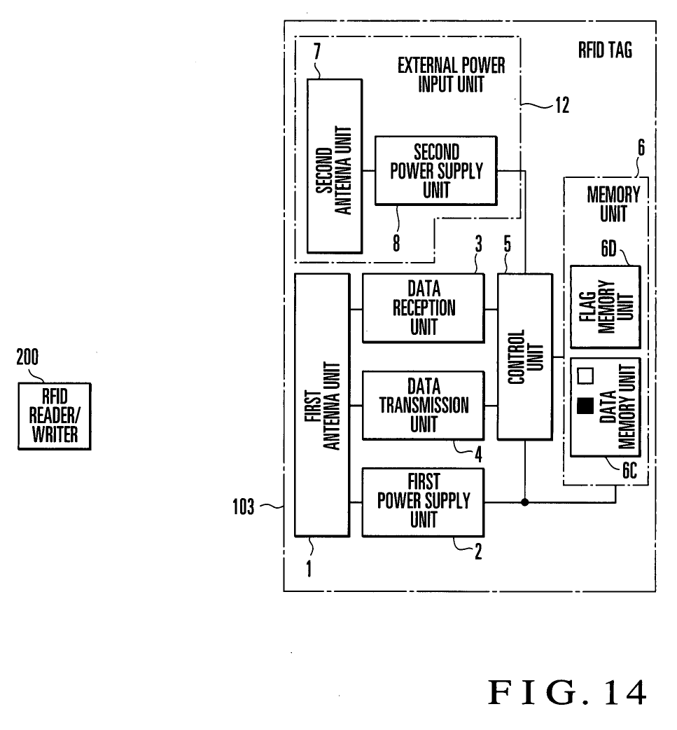

FIG. 14 shows the schematic arrangement of an RFID tag according to the fifth embodiment of the present invention. An RFID tag 103 of the fifth embodiment has an arrangement in which a memory unit 6 is divided into a data memory unit 6C and a flag memory unit 6D. The data memory unit 6C stores an ID, user data, and the like. The flag memory unit 6D stores flag values indicating whether data stored at the addresses in the data memory 6C need protection.

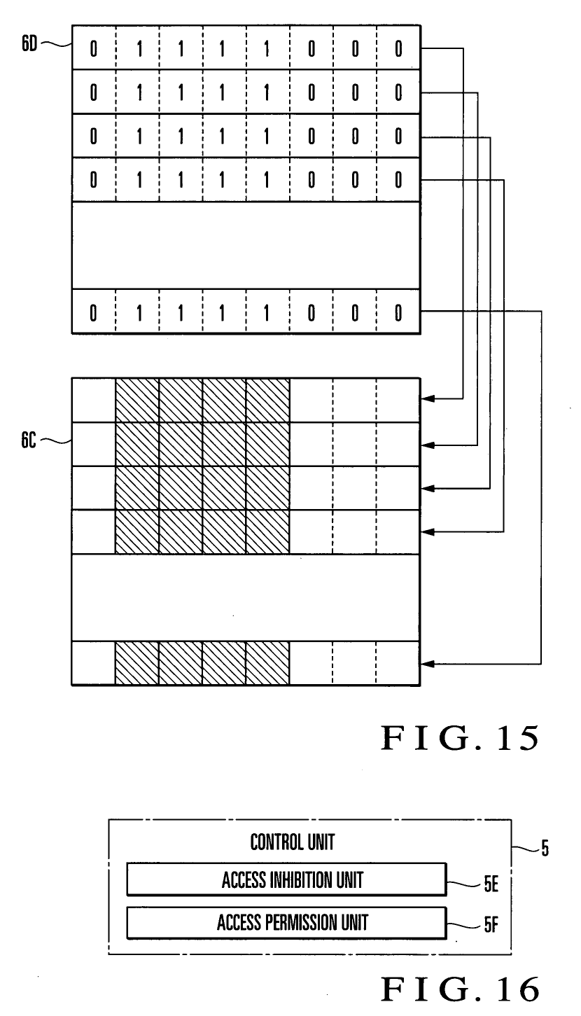

FIG. 15 shows the relationship between the respective addresses in the data memory unit 6C and the flag values in the flag memory unit 6D. The data memory unit 6C and the flag memory unit 6D have the same address arrangement. At the respective addresses in the flag memory unit 6D, flag values designating permission/inhibition (protection/no protection) of data write access and data read access to the corresponding addresses in the data memory unit 6C are stored. In this embodiment, a flag value of “1” represents a protected state, and a flag value of “0” represents an unprotected state. With this setting, as indicated by the hatchings in the data memory unit 6C, addresses, of the addresses in the data memory unit 6C, at which the flag value “1” is stored in the flag memory unit 6D are set as addresses in the protected state.

This example designates protection/no protection for each address in the data memory unit 6C. It is also possible to divide the data memory unit 6C into blocks each comprising multiple addresses and designate protection/no protection for each block in the flag memory unit 6D.

As shown in FIG. 16, a control unit 5 has two functional units, i.e., an access inhibition unit 5E and an access permission unit 5F. The access inhibition unit 5E inhibits access from an RFID reader/writer 200 to the flag memory unit 6D through a first antenna unit 1 if no power is received from a second power supply unit 8, and also inhibits access from the RFID reader/writer 200 to a data storage area in the data memory unit 6C, which is in protected state by a flag value in the flag memory unit 6D, through the first antenna unit 1. The access permission unit 5F permits access from the RFID reader/writer 200 to the flag memory unit 6D through the first antenna unit 1 if power is received from the second power supply unit 8, and also permits access from the RFID reader/writer 200 to a data storage area in the data memory unit 6C, which is in protected state by a flag value in the flag memory unit 6D, through the first antenna unit 1.

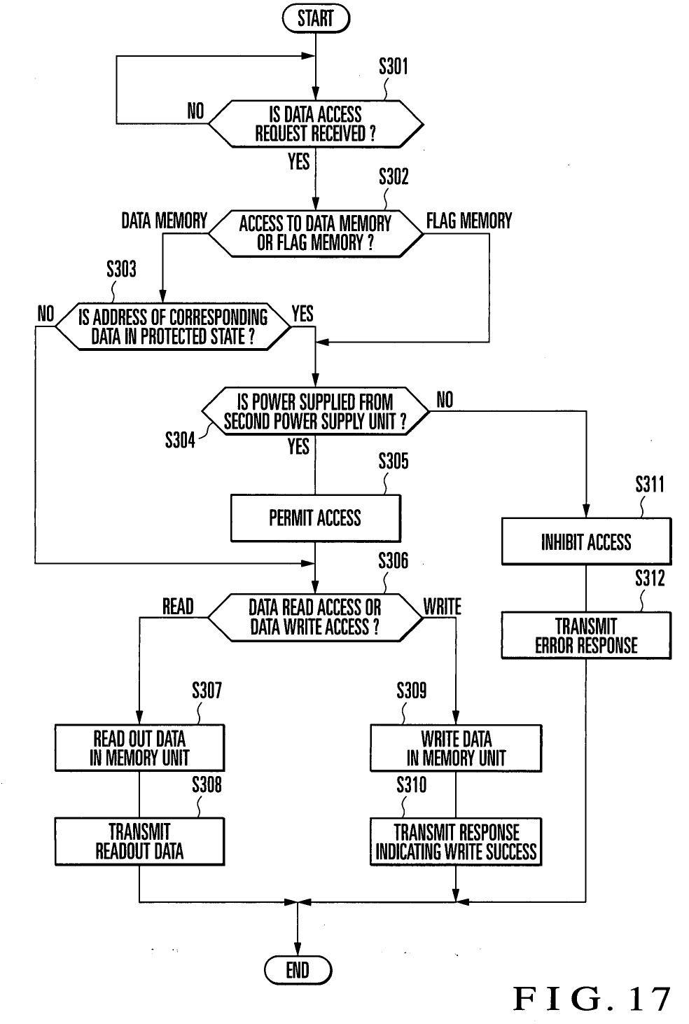

The access inhibition/permission function of the control unit 5 of the RFID tag 103 according to the fifth embodiment will be described below with reference to the flowchart shown in FIG. 17.

### [If RFID Reader/Writer is Located at Long Distance]

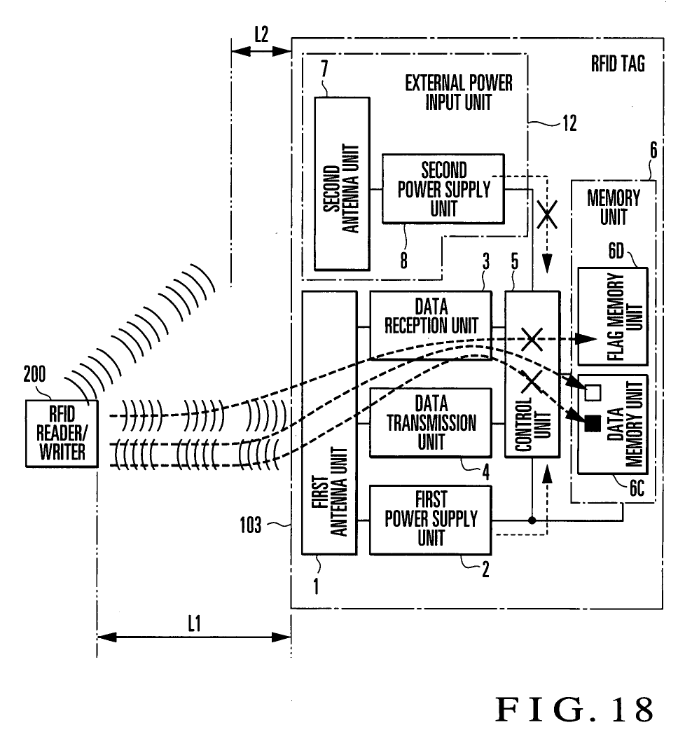

Assume that as shown in FIG. 18, the RFID reader/writer 200 is located at a long distance (between L1 and L2). In this case, a first antenna unit 1 of an RFID tag 102 receives a radio wave from the RFID reader/writer 200, and a first power supply unit 2 supplies power extracted from the radio wave received by the first antenna unit 1 to the control unit 5. The control unit 5 operates upon receiving the power from the first power supply unit 2, and checks whether the command contained in the radio wave received by the first antenna unit 1 is a data access request (step S301).

If the command from the RFID reader/writer 200 is a data access request (YES in step S301), the control unit 5 checks whether the command is an access request to the data memory unit 6C or an access request to the flag memory unit 6D (step S302). If the command is an access request to the data memory unit 6C, the process advances to step S303. If the command is an access request to the flag memory unit 6D, the process advances to step S304.

### [If Command is Access Request to Flag Memory Unit]

If the command is an access request to the flag memory unit 6D, the control unit 5 checks whether power is supplied from the second power supply unit 8 (step S304). If no power is supplied from the second power supply unit 8 (NO in step S304), the process advances to step S311. If power is supplied from the second power supply unit 8 (YES in step S304), the process advances to step S305.

In this case, since the RFID reader/writer 200 is located between L1 and L2, the power of radio waves from the RFID reader/writer 200 is insufficient for the reception sensitivity of a second antenna unit 7. Therefore, the second power supply unit 8 cannot extract power, and hence sends no power to the control unit 5. In accordance with NO in step S304, the control unit 5 advances to step S311 to inhibit access to the flag memory unit 6D which is based on the data access request received in step S301 and transmits an error response to the RFID reader/writer 200 through a data transmission unit 4 (step S312).

### [If Command is Access Request to Data Memory Unit]

If the command is an access request to the data memory unit 6C, the control unit 5 checks whether the address in the data memory unit 6C to which the access requested is in the protected state, by accessing the corresponding address in the flag memory unit 6D (step S303). If the address is in the protected state (YES in step S303), the process advances to step S304. If the address in not in the protected state (NO in step S303), the process advances to step S306.

### [If Address is in Protected State]

If the address in the data memory unit 6C to which the access requested is in the protected state (YES in step S303), the control unit 5 checks whether power is supplied from the second power supply unit 8 (step S304). If no power is supplied from the second power supply unit 8, the process advances to step S311. If power is supplied from the second power supply unit 8, the process advances to step S305.

In this case, since the RFID reader/writer 200 is located between L1 and L2, the power of radio waves from the RFID reader/writer 200 is insufficient for the reception sensitivity of a second antenna unit 7. Therefore, the second power supply unit 8 cannot extract power, and hence the second power supply unit 8 sends no power to the control unit 5. In accordance with NO in step S304, the control unit 5 advances to step S311 to inhibit access to the data memory unit 6C which is based on the data access request received in step S301 and transmit an error response to the RFID reader/writer 200 through the data transmission unit 4 (step S312).

### [If Address is not in Protected State (in Unprotected State)]

If the address in the data memory unit 6C to which the access request is issued is not in the protected state (NO in step S303), the control unit 5 determines that it is possible to access the data memory unit 6C, and checks whether the access request is a data read request or a data write request (step S306).

If the access request is a data read request, the control unit 5 reads out the requested data from the data memory unit 6C (step S307), and returns the readout data to the RFID reader/writer 200 through the data transmission unit 4 (step S308).

If the access request is a data write request, the control unit 5 writes the received data in the data memory unit 6C (step S309), and returns information indicating a write success to the RFID reader/writer 200 through the data transmission unit 4 (step S310).

In this case, the RFID reader/writer 200 may not be an authorized communication device but may be a malicious communication device. The fifth embodiment permits access from the RFID reader/writer 200 at a long distance to an unprotected address in the data memory unit 6C in the RFID tag 102 and inhibits access to a protected address regardless of whether the RFID reader/writer 200 is an authorized communication device. This allows access from a long distance to data requiring no protection and can properly protect only data requiring protection against unauthorized access from a long distance.

In addition, the fifth embodiment inhibits access from the RFID reader/writer 200 at a long distance to the flag memory unit 6D regardless of whether the RFID reader/writer 200 is an authorized communication device. This eliminates the possibility of malicious rewriting the designation of a protected state or an unprotected state with respect to the address in the data memory unit 6C.

### [When RFID Reader/Writer is Located at Short Distance]

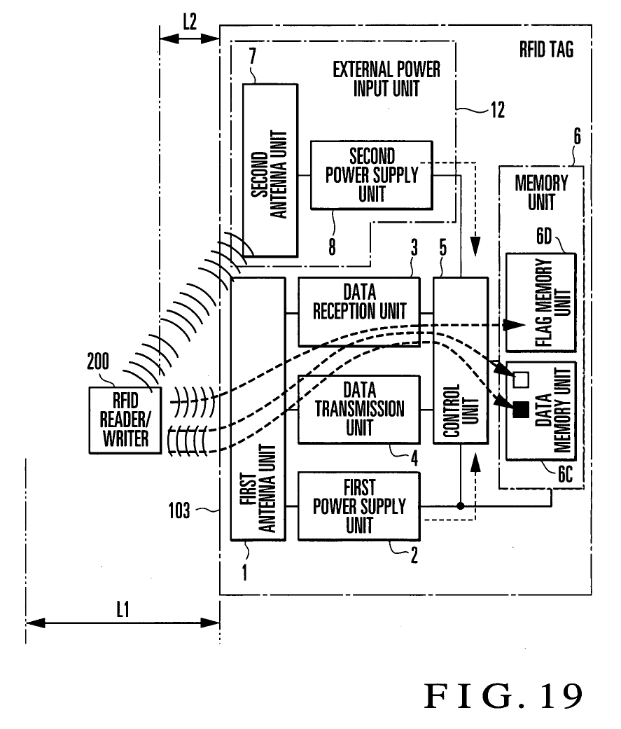

Assume that as shown in FIG. 19, the RFID reader/writer 200 is located at a short distance (within L2). In this case, the power of radio waves from the RFID reader/writer 200 is sufficiently high for the reception sensitivity of the second antenna unit 7 of the RFID tag 102. This makes the first power supply unit 2 extract power from the radio wave received by the first antenna unit 1, and makes the second power supply unit 8 extract power from the radio wave received by the second antenna unit 7. The first and second power supply units then send the extracted power to the control unit 5. The control unit 5 operates upon receiving the power from the first power supply unit 2, and checks whether the command contained in the radio wave received by the first antenna unit 1 is a data access request (step S301).

If the command from the RFID reader/writer 200 is a data access request (YES in step S301), the control unit 5 checks whether the command is an access request to the data memory unit 6C or an access request to the flag memory unit 6D (step S302). If the command is an access request to the data memory unit 6C, the process advances to step S303. If the command is an access request to the flag memory unit 6D, the process advances to step S304.

### [If Command is Access Request to Flag Memory Unit]

If the command is an access request to the flag memory unit 6D, the control unit 5 checks whether power is supplied from the second power supply unit 8 (step S304). If no power is supplied from the second power supply unit 8 (NO in step S304), the process advances to step S311. If power is supplied from the second power supply unit 8 (YES in step S304), the process advances to step S305.

In this case, since the RFID reader/writer 200 is located within L2, the power of radio waves from the RFID reader/writer 200 is sufficiently high for the reception sensitivity of the second antenna unit 7, and the control unit 5 receives power from the second power supply unit 8. For this reason, in accordance with YES in step S304, the control unit 5 advances to step S305 to permit access to the flag memory unit 6D which is based on the data access request received in step S301. The control unit 5 then checks whether the access request to the flag memory unit 6D is a data read request or a data write request (step S306).

If the access request is a data read request, the control unit 5 reads out the requested data from the data memory unit 6C (step S307), and returns the readout data to the RFID reader/writer 200 through the data transmission unit 4 (step S308).

If the access request is a data write request, the control unit 5 writes the received data in the flag memory unit 6D (step S309), and returns information indicating a write success to the RFID reader/writer 200 through the data transmission unit 4 (step S310).

### [If Command is Access Request to Data Memory Unit]

If the command is an access request to the data memory unit 6C, the control unit 5 checks whether the address in the data memory unit 6C to which the access requested is in the protected state, by accessing the corresponding address in the flag memory unit 6D (step S303). If the address is in the protected state (YES in step S303), the process advances to step S304. If the address in not in the protected state (NO in step S303), the process advances to step S306.

### [If Address is in Protected State]

If the address in the data memory unit 6C to which the access requested is in the protected state (YES in step S303), the control unit 5 checks whether power is supplied from the second power supply unit 8 (step S304). If no power is supplied from the second power supply unit 8, the process advances to step S311. If power is supplied from the second power supply unit 8 (YES in step S304), the process advances to step S305.

In this case, since the RFID reader/writer 200 is located within L2, the power of radio waves from the RFID reader/writer 200 is sufficiently high for the reception sensitivity of the second antenna unit 7, and the second power supply unit 8 supplies power to the control unit 5. Therefore, in accordance with YES in step S304, the control unit 5 advances to step S305 to permit access to the data memory unit 6C which is based on the data access request received in step S301. The control unit 5 then checks whether the access request to the data memory unit 6C is a data read request or data write request (step S306).

If the access request is a data read request, the control unit 5 reads out the requested data from the access inhibition unit 5C (step S307), and returns the readout data to the RFID reader/writer 200 through the data transmission unit 4 (step S308).

If the access request is a data write request, the control unit 5 writes the received data in the data memory unit 6C (step S309), and returns information indicating a write success to the RFID reader/writer 200 through the data transmission unit 4 (step S310).

### [If Address is not in Protected State (in Unprotected State)]

If the address in the data memory unit 6C to which the access requested is not in the protected state (NO in step S303), the control unit 5 checks whether the access request is a data read request or a data write request (step S306). The control unit 5 performs read processing (steps S307 and S308) of data from the data memory unit 6C or write processing (steps S309 and S310) of data in the data memory unit 6C in accordance with the check result.

Note that the access inhibition unit 5E of the control unit 5 performs the processing in step S311 if NO in step S304, and the access permission unit 5D performs the processing in step S305 if YES in step S304.

In this case, the RFID reader/writer 200 may not be an authorized communication device but may be a malicious communication device. The fifth embodiment permits all access from the RFID reader/writer 200 at a short distance to the data memory unit 6C in the RFID tag 103 regardless of whether the RFID reader/writer 200 is an authorized communication device and the accessed data is the protected state/unprotected state. This embodiment also permits access to the flag memory unit 6D in the RFID tag 103. Even if some person has made malicious access, since such access must be made from a short distance, the user of an RFID tag can easily visually check the access. This can prevent any person from making malicious access without letting the user of the RFID tag 103 consent to or notice it.

### Sixth Embodiment

The RFID tag 103 shown in FIG. 14 is configured such that the first antenna unit 1 and the second antenna unit 7 use the same frequency band for communication. However, the frequency band of the first antenna unit 1 may differ from that of the second antenna unit 7, and the RFID tag 103 may include another radio wave source to the second antenna unit 7.

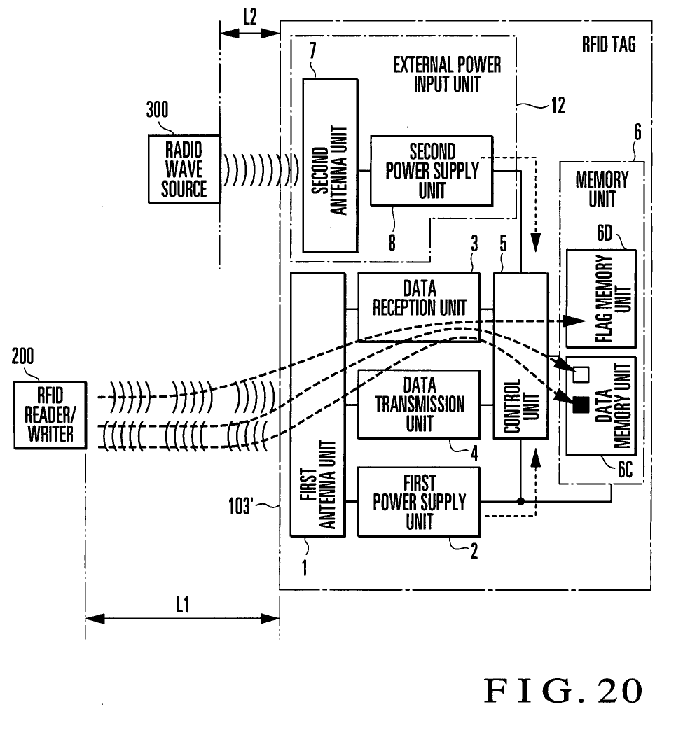

For example, as shown in FIG. 20, the frequency band of a first antenna unit 1 is made to differ from that of a second antenna unit 7, and a radio wave source 300 is provided for the second antenna unit 7 independently of an RFID reader/writer 200.

According to an RFID tag 103′, when the radio wave source 300 is located within a communicable distance L2 of the second antenna unit 7, the second antenna unit 7 receives a radio wave from the radio wave source 300. Since the power of the received radio wave is sufficiently high for the reception sensitivity of the second antenna unit 7, a second power supply unit 8 extracts power from the received radio wave. This makes a control unit 5 permit access from the RFID reader/writer 200 to a protected address in a data memory unit 6C.

According to the sixth embodiment, using the radio wave source 300 allows access from the RFID reader/writer 200 to a protected address in the data memory unit 6C in the RFID tag 103′ regardless of whether the RFID reader/writer 200 is an authorized communication device. Since the radio wave source 300 must be brought close to the RFID tag 103′, the user can easily visually check malicious access.

### Seventh Embodiment

The third embodiment uses the second antenna unit 7 and the second power supply unit 8 only for the purpose of determining whether to permit access from the RFID reader/writer 200 to the protected memory unit 6A through the first antenna unit 1, and cannot perform data communication through the second antenna unit 7. The seventh embodiment therefore includes a second data reception unit and a second data transmission unit for a second antenna unit 7 to allow data communication through the second antenna unit 7, thereby further improving the convenience in using data.

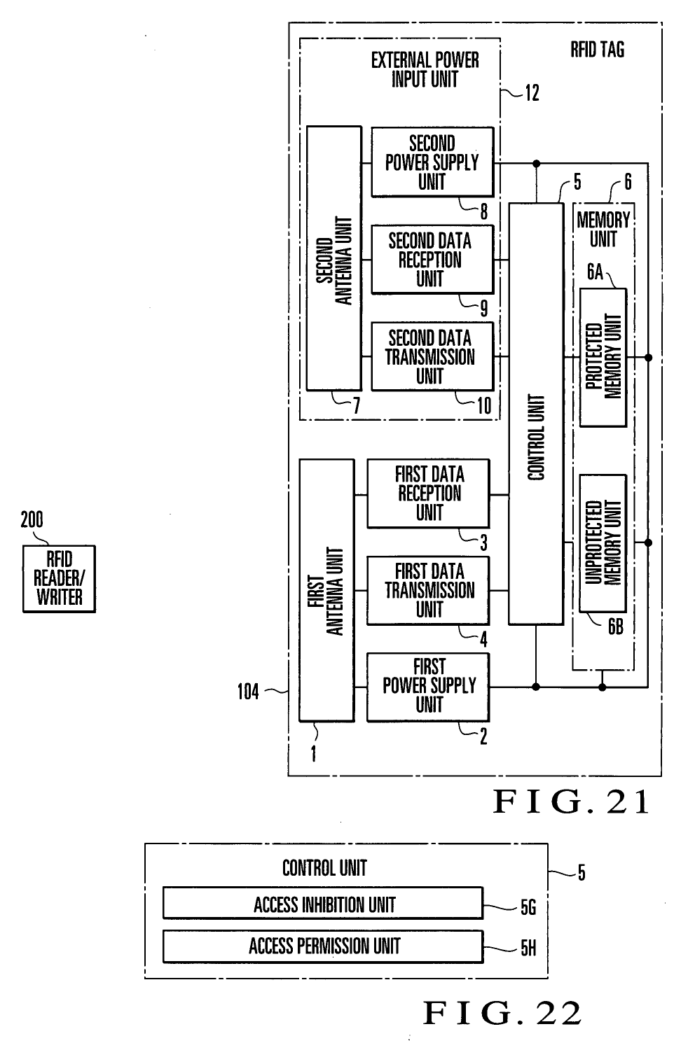

FIG. 21 shows the schematic arrangement of an RFID tag according to the seventh embodiment of the present invention. An RFID tag 104 according to the seventh embodiment is obtained by partially changing the arrangement of the RFID tag 102 according to the third embodiment. That is, this embodiment uses an external power input unit 12 not only for the supply of external power but also for data communication with an RFID reader/writer 200.

More specifically, this embodiment includes a data reception unit 3 and a data transmission unit 4 for a first antenna unit 1 as a first data reception unit and a first data transmission unit, respectively. In addition, the external power input unit 12 includes a second data reception unit 9 and a second data transmission unit 10 in addition to a second antenna unit 7 and a second power supply unit 8. Like the data reception unit 3, the second data reception unit 9 decodes the command contained in the radio wave received from the RFID reader/writer 200 and transmits the resultant data to a control unit 5. Like the data transmission unit 4, the second data transmission unit 10 encodes the return data transmitted from the control unit 5 in a transmission radio wave from the second antenna unit 7.

As shown in FIG. 22, the control unit 5 comprises two functional units, i.e., an access inhibition unit 5G which inhibits access from the RFID reader/writer 200 to a protected memory unit 6A through the first antenna unit 1 if no power is received from the second power supply unit 8, and an access permission unit 5H which permits access from the RFID reader/writer 200 to the protected memory unit 6A through the second antenna unit 7 if power is received from the second power supply unit 8.

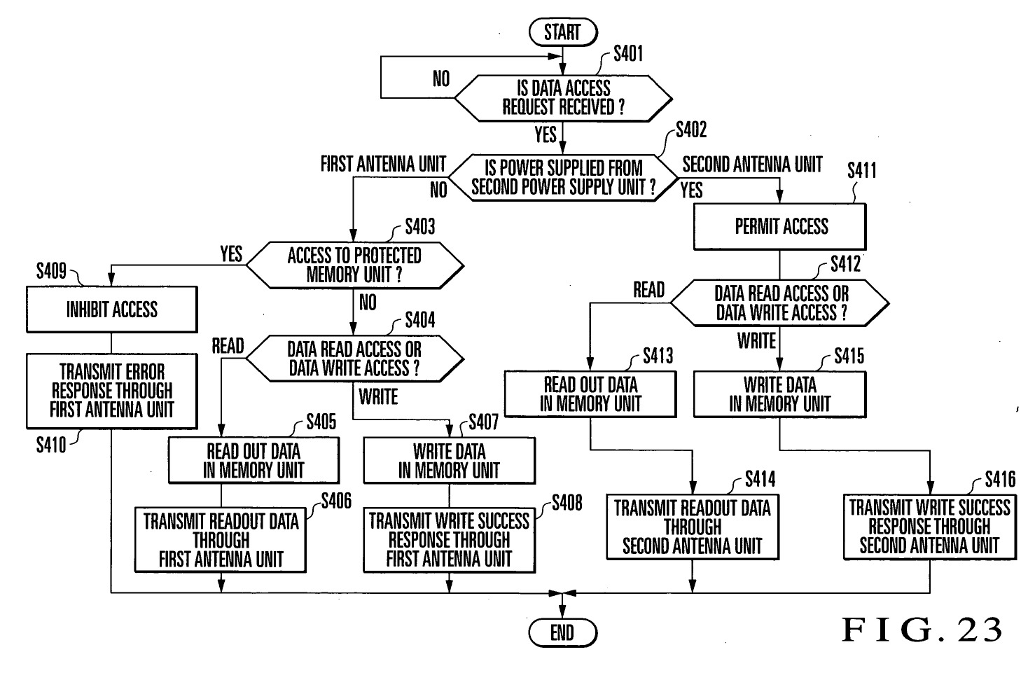

The access inhibition/permission function of the control unit 5 of the RFID tag 104 according to the seventh embodiment will be described below with reference to the flowchart shown in FIG. 23.

### [When RFID Reader/Writer is Located at Long Distance]

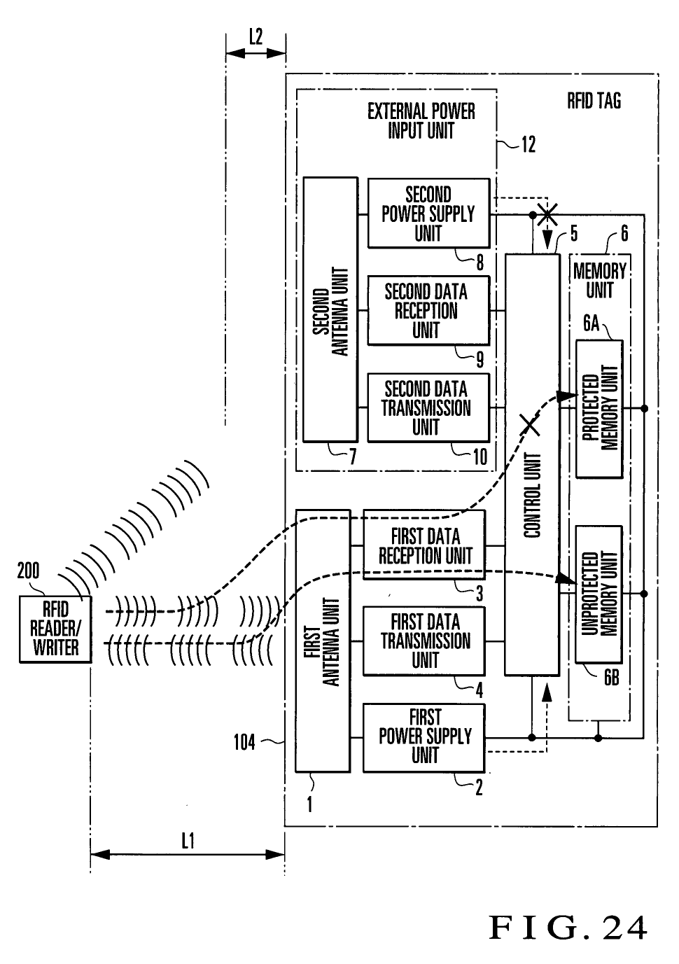

Assume that as shown in FIG. 24, the RFID reader/writer 200 is located at a long distance (between L1 and L2). In this case, the first antenna unit 1 of the RFID tag 102 receives a radio wave from the RFID reader/writer 200, and a first power supply unit 2 supplies power extracted from the radio wave received by the first antenna unit 1 to the control unit 5. The control unit 5 operates upon receiving the power from the first power supply unit 2, and checks whether the command contained in the radio wave received by the first antenna unit 1 is a data access request (step S401).

If the command from the RFID reader/writer 200 is a data access request (YES in step S401), the control unit 5 checks whether power is supplied from the second power supply unit 8 (step S402). If no power is supplied from the second power supply unit 8 (NO in step S402), the process advances to step S403. If power is supplied from the second power supply unit 8 (YES in step S402), the process advances to step S411.

In this case, since the RFID reader/writer 200 is located between L1 and L2, the power of radio waves from the RFID reader/writer 200 is insufficient for the reception sensitivity of the second antenna unit 7. Therefore, the second power supply unit 8 cannot extract power, and hence the second power supply unit 8 sends no power to the control unit 5. In accordance with NO in step S402, the control unit 5 advances to step S403 to check whether the data access request received through the first antenna unit 1 is an access request to the protected memory unit 6A.

### [If Data Access Request is Access Request to Protected Memory Unit]

If the data access request is an access request to the protected memory unit 6A (YES in step S403), the control unit 5 inhibits access to the protected memory unit 6A which is based on the data access request received in step S401 (step S409), and transmits an error response to the RFID reader/writer 200 through the data transmission unit 4 (step S410).

### [If Data Access Request is not Access Request to Protected Memory Unit]

If the data access request is not an access request to the protected memory unit 6A (NO in step S403), the control unit 5 determines that the data access request is an access request to the unprotected memory unit 6B, and checks whether the access request is a data read request or a data write request (step S404).

If the access request is a data read request, the control unit 5 reads out the requested data from an unprotected memory unit 6B (step S405), and returns the readout data to the RFID reader/writer 200 through the data transmission unit 4 (step S406).

If the access request is a data write request, the control unit 5 writes the first received data in the unprotected memory unit 6B (step S407), and returns information indicating a write success to the RFID reader/writer 200 through the data transmission unit 4 (step S408).

In this case, the RFID reader/writer 200 may not be an authorized communication device but may be a malicious communication device. The seventh embodiment inhibits access from the RFID reader/writer 200 at a long distance to the protected memory unit 6A in the RFID tag 104 regardless of whether the RFID reader/writer 200 is an authorized communication device. This allows access from a long distance to data requiring no protection and can protect only data requiring protection against malicious access from a long distance.

### [When RFID Reader/Writer is Located at Short Distance]

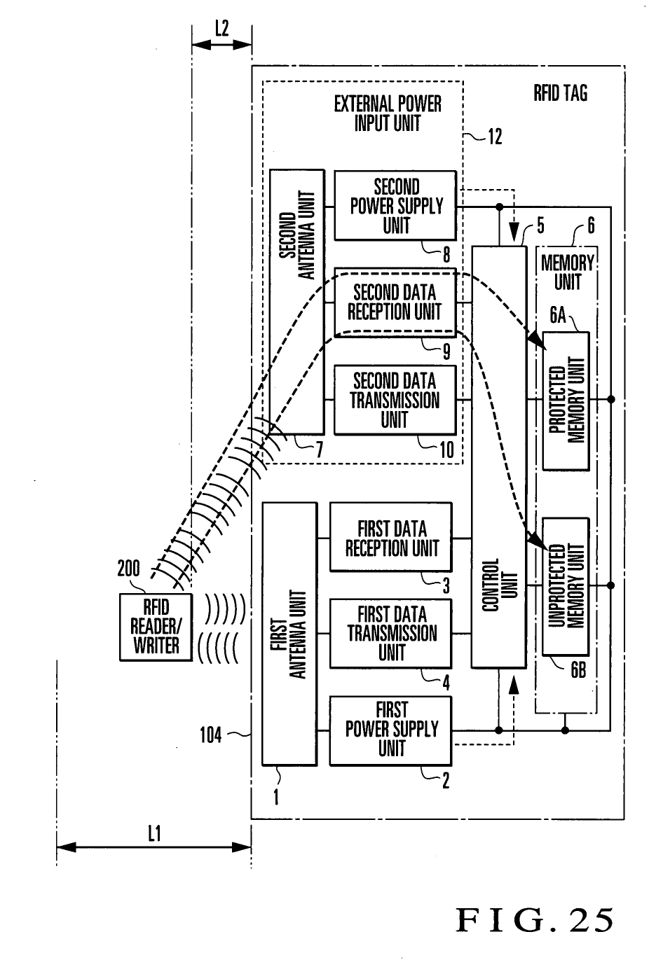

Assume that as shown in FIG. 25, the RFID reader/writer 200 is located at a short distance (within L2). In this case, the power of radio waves from the RFID reader/writer 200 is sufficiently high for the reception sensitivity of the second antenna unit 7 of the RFID tag 104. This makes the first power supply unit 2 extract power from the radio wave received by the first antenna unit 1, and makes the second power supply unit 8 extract power from the radio wave received by the second antenna unit 7. The first and second power supply units then send the extracted power to the control unit 5. The control unit 5 operates upon receiving power from the first power supply unit 2, and checks whether the command contained in the radio wave received by the first antenna unit 1 is a data access request (S401).

If the command from the RFID reader/writer 200 is a data access request (YES in step S401), the control unit 5 checks whether power is supplied from the second power supply unit 8 (step S402). If no power is supplied from the second power supply unit 8 (NO in step S402), the process advances to step S403. If power is supplied from the second power supply unit 8 (YES in step S402), the process advances to step S411.

In this case, since the RFID reader/writer 200 is located within L2, the power of radio waves from the RFID reader/writer 200 is sufficiently high for the reception sensitivity of the second antenna unit 7, and the second power supply unit 8 supplies power to the control unit 5. Therefore, in accordance with YES in step S402, the control unit 5 advances to step S411. In step S411, the control unit 5 validates the data access request received through the second antenna unit 7, and permits all access to the memory unit 6 including the protected memory unit 6A which is based on the data access request. The control unit 5 then checks whether the access request is a data read request or a data write request (step S412).

If the access request is a data read request, the control unit 5 reads out the requested data from the memory unit 6 (the protected memory unit 6A or the unprotected memory unit 6B) (step S413), and returns the readout data to the RFID reader/writer 200 through the second data transmission unit 10 (step S414).

If the access request is a data write request (“write” in step S412), the control unit 5 writes the received data in the memory unit 6 (the protected memory unit 6A or the unprotected memory unit 6B) (step S415), and returns information indicating a write success to the RFID reader/writer 200 through the second data transmission unit 10 (step S416).

Note that if NO in step S402 and YES in step S403, the access inhibition unit 5G of the control unit 5 performs the processing in step S409. If YES in step S402, the access permission unit 5H performs the processing in step S411.

In this case, the RFID reader/writer 200 may not be an authorized communication device but may be a malicious communication device. The seventh embodiment permits access from the RFID reader/writer 200 at a short distance to the protected memory unit 6A in the RFID tag 104 regardless of whether the RFID reader/writer 200 is an authorized communication device. Even if some person has made malicious access, since such access must be made from a short distance, the user of an RFID tag can easily visually check the access. This can prevent any person from making malicious access without letting the user of the RFID tag 104 consent to or notice it.

The RFID tag 103 according to the fifth embodiment shown in FIG. 14 can have the same effect as that of the seventh embodiment by having the second antenna unit 7, second power supply unit 8, second data reception unit 9, and second data transmission unit 10. In this case, an access inhibition unit 5E of the control unit 5 in the RFID tag 103 of the fifth embodiment inhibits access from the RFID reader/writer 200 to a flag memory unit 6D through the first antenna unit 1 if no power is received from the second power supply unit 8, and also inhibits access from the RFID reader/writer 200 to the data storage area in a data memory unit 6C, which is in protected state by a flag value in the flag memory unit 6D, through the first antenna unit 1. If power is received from the second power supply unit 8, an access permission unit 5F permits access from the RFID reader/writer 200 to the flag memory unit 6D through the second antenna unit 7 if power is received from the second power supply unit 8, and also permits access from the RFID reader/writer 200 to the data storage area in the data memory unit 6C, which is in protected state by a flag value in the flag memory unit 6D, through the second antenna unit 7.

### Eighth Embodiment

The RFID tag 104 shown in FIG. 21 is configured such that the first antenna unit 1 and the second antenna unit 7 use the same frequency band for communication. However, the frequency band of the first antenna unit 1 may differ from that of the second antenna unit 7, and the RFID tag 104 may include another RFID reader/writer which performs data communication through the second antenna unit 7.

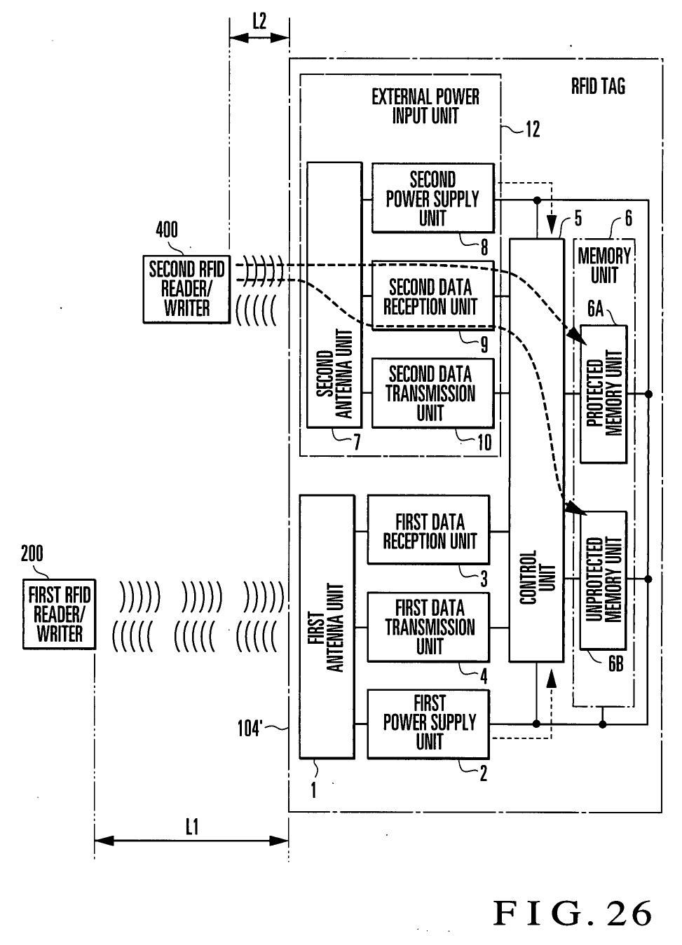

For example, as shown in FIG. 26, the frequency band of a first antenna unit 1 is made to differ from that of a second antenna unit 7, and this embodiment includes a second RFID reader/writer 400 which performs data communication through the second antenna unit 7 separately from an RFID reader/writer 200 which performs data communication through the first antenna unit 1.

According to an RFID tag 104′, when the second RFID reader/writer 400 is located within a communicable distance L2 of the second antenna unit 7, the second antenna unit 7 receives a radio wave from the second RFID reader/writer 400. Since the power of the received radio wave is sufficiently high for the reception sensitivity of the second antenna unit 7, a second power supply unit 8 extracts power from the received radio wave. This makes a control unit 5 validate the data access request received through the second antenna unit 7, and allows all access from the second RFID reader/writer 400 to a memory unit 6 including a protected memory unit 6A.

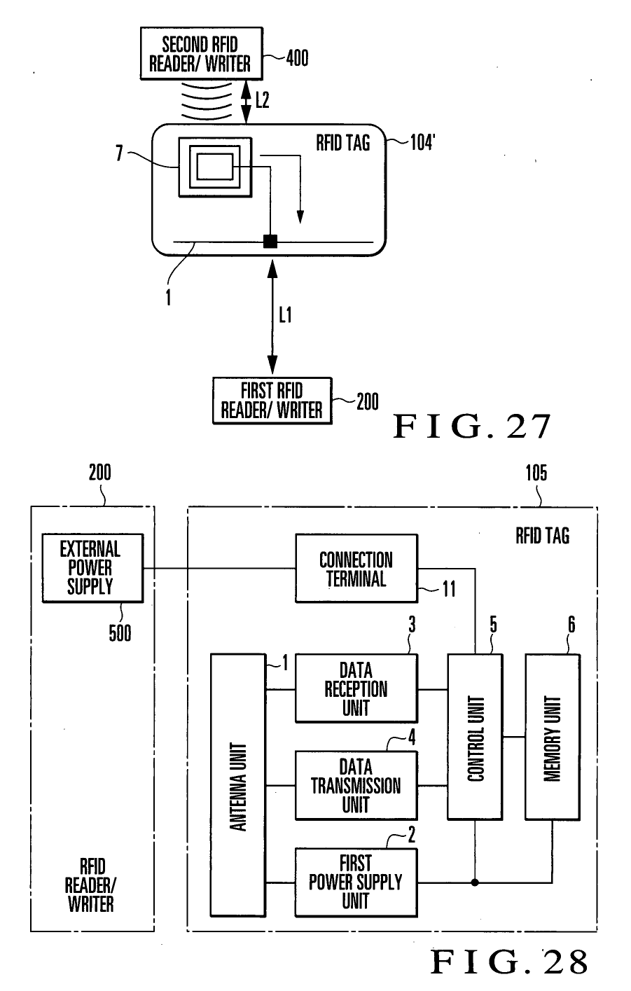

According to the eighth embodiment, using the second RFID reader/writer 400 allows access to the protected memory unit 6A in the RFID tag 104′ regardless of whether the RFID reader/writer 200 is an authorized communication device. Since the RFID reader/writer 400 must be brought close to the RFID tag 104′, the user can easily visually check malicious access. FIG. 27 shows how the user uses the RFID tag 104′.

### Ninth Embodiment

FIG. 28 shows the schematic arrangement of an RFID tag according to the ninth embodiment of the present invention. An RFID tag 105 of the ninth embodiment comprises a connection terminal 11 to an external power supply 500 instead of the second antenna unit 7 and the second power supply unit 8 as external power input units as compared with the RFID tag 101 of the first embodiment.

The first embodiment extracts external power from the radio wave received through the second antenna unit 7, and the control unit 5 determines, in accordance with the presence/absence of input of the extracted external power, whether to permit/inhibit access to the memory unit 6. In the ninth embodiment, a control unit 5 determines, in accordance with the presence/absence of input of external power from the connection terminal 11, whether to permit/inhibit access to a memory unit 6. The arrangement of the control unit 5 in the ninth embodiment is the same as that of the first embodiment, and a description thereof will be omitted.

The ninth embodiment includes the external power supply 500 in an RFID reader/writer 200. With this arrangement, the external power supply 500 does not connect to the connection terminal 11 unless the RFID tag 105 has physical contact with the RFID reader/writer 200, thereby preventing malicious contactless access. Even if some person has made malicious access, since such access must be made by making a malicious RFID reader/writer have physical contact with an RFID tag, the user can easily visually check the access.

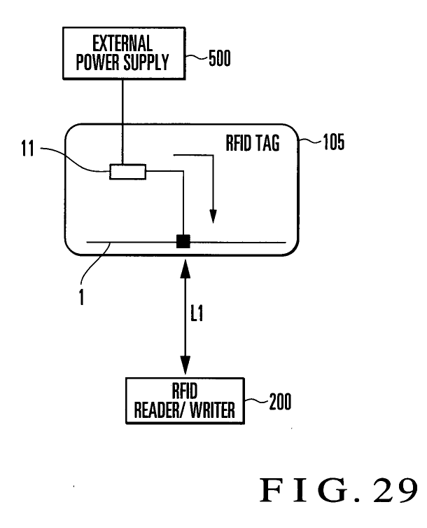

Note that the operation of the ninth embodiment is the same as that of the flowchart shown in FIG. 3 except that “IS POWER SUPPLIED FROM SECOND POWER SUPPLY UNIT?” in step S102 is replaced with “IS POWER SUPPLIED FROM CONNECTION TERMINAL?”, and hence a description thereof will be omitted. FIG. 29 shows how the RFID tag 105 is used.

Although the ninth embodiment provides the external power supply 500 for the RFID reader/writer 200, the external power supply 500 can be provided outside of the RFID reader/writer 200.

Letting the RFID tag 102 (FIG. 8) of the third embodiment or the RFID tag 103 (FIG. 14) of the fifth embodiment have the connection terminal 11 for the external power supply 500 instead of the second antenna unit 7 and the second power supply unit 8 as external power input units makes it possible to obtain the same effects as those of the RFID tag 105 of the ninth embodiment.

Each embodiment described above uses the RFID reader/writer capable of reading and writing data as a communication device which performs data communication with an RFID tag. However, each embodiment may use an RFID reader capable of only reading out data as a communication device.

Reference 2 (Japanese Patent Laid-Open No. 2001-167241) and reference 3 (Japanese Patent Laid-Open No. 2004-213582) disclose arrangements having a second antenna unit provided for an RFID tag, having a second antenna unit smaller in size than a first antenna unit, and the like. Reference 4 (Japanese Patent Laid-Open No. 2003-283366) discloses an arrangement in which a memory unit includes a flag storage unit for indicating protection/no protection of data. However, these references only partially describe part of the features of the present invention, but disclose nothing about important techniques, e.g., controlling permission and inhibition of access from a communication device to a memory unit in accordance with presence/absence of input of external power from the second power supply unit and the connection terminal.

As described above, the RFID tag 101 of the present invention includes, as the external power input unit 12, the second antenna unit 7 having lower radio wave reception sensitivity than the first antenna unit 1 and the second power supply unit 8 which extracts power from the radio wave received by the second antenna unit 7. The control unit 5 includes an access inhibition unit 5A which inhibits access from a communication device to the memory unit 6 through the first antenna unit 1 if no power is received from the second power supply unit 8, and an access permission unit 5B which permits access from the communication device to the memory unit 6 through the first antenna unit 1 if power is received from the second power supply unit 8.

With this arrangement, when a communication device is located at a long distance from the RFID tag 101 (between the communicable distance of the first antenna unit 1 and the communicable distance of the second antenna unit 7), the first antenna unit 1 of the RFID tag 101 receives a radio wave from the communication device. This makes the first power supply unit 2 extract power from the radio wave received by the first antenna unit 1 and send the extracted power to the control unit 5. In this case, however, since the power of radio waves from the communication device is insufficient for the reception sensitivity of the second antenna unit 7, the second power supply unit 8 cannot extract power, and hence sends no power (external power) to the control unit 5. This inhibits access from the communication device to the memory unit 6 through the first antenna unit 1, i.e., access from the communication device at a long distance to the memory unit 6 in the RFID tag 101. This prevents malicious access from a long distance.

In contrast, when the communication device is located at a short distance from the RFID tag 101 (within the communicable distance of the second antenna unit 7), the power of radio waves from the communication device is sufficiently high for the reception sensitivity of the second antenna unit 7. This makes the first power supply unit 2 extract power from the radio wave received by the first antenna unit 1 and also makes the second power supply unit 8 extract power from the radio wave received by the second antenna unit 7. The first and second antenna units send the extracted power to the control unit 5. This therefore permits access from the communication device to the memory unit 6 through the first antenna unit 1, i.e., access from the communication device at a short distance to the memory unit 6 in the RFID tag 101, thereby allowing data write access and data read access to the memory unit 6. Even if some person has made malicious access, since such access must be made from a short distance, the user can easily visually check the access.

The RFID tag 102 of the present invention includes, as the external power input unit 12, the second antenna unit 7 having lower radio wave reception sensitivity than the first antenna unit 1 and the second power supply unit 8 which extracts power from the radio wave received by the second antenna unit 7. The memory unit 6 includes the protected memory unit 6A which stores data needing protection and the unprotected memory unit 6B which stores data needing no protection. In addition, the control unit 5 includes the access inhibition unit 5C which inhibits access from a communication device to the protected memory unit 6A through the first antenna unit 1 if no power is received from the second power supply unit 8, and the access permission unit 5D which permits access from the communication device to the protected memory unit 6A through the first antenna unit 1 if power is received from the second power supply unit 8.

With this arrangement, when a communication device is located at a long distance from the RFID tag 102 (between the communicable distance of the first antenna unit 1 and the communicable distance of the second antenna unit 7), the first antenna unit 1 of the RFID tag 102 receives a radio wave from the communication device. This makes the first power supply unit 2 extract power from the radio wave received by the first antenna unit 1 and send the extracted power to the control unit 5. In this case, since the power of radio waves from the communication device is insufficient for the reception sensitivity of the second antenna unit 7, the second power supply unit 8 cannot extract power, and hence cannot send power (external power) to the control unit 5. This inhibits access from the communication device to the protected memory unit 6A through the first antenna unit 1, i.e., access from the communication device at a long distance to the protected memory unit 6A in the RFID tag 102. Note that this arrangement allows access from the communication device to the unprotected memory unit 6B through the first antenna unit 1, i.e., access from the communication device at a long distance to the unprotected memory unit 6B in the RFID tag 102. This allows access from a long distance to data requiring no protection and can properly protect only data requiring protection against malicious access from a long distance.

In contrast, when the communication device is located at a short distance from the RFID tag 102 (within the communicable distance of the second antenna unit 7), the power of radio waves from the communication device is sufficiently high for the reception sensitivity of the second antenna unit 7. This makes the first power supply unit 2 extract power from the radio wave received by the first antenna unit 1 and also makes the second power supply unit 8 extract power from the radio wave received by the second antenna unit 7. The first and second antenna units send the extracted power to the control unit 5. This therefore permits access from the communication device to the protected memory unit 6A through the first antenna unit 1, i.e., access from the communication device at a short distance to the protected memory unit 6A in the RFID tag 102, thereby allowing data write access and data read access to the protected memory unit 6A. Even if some person has made malicious access, since such access must be made from a short distance, the user can easily visually check the access.

The RFID tag 103 of the present invention includes, as the external power input unit 12, the second antenna unit 7 having lower radio wave reception sensitivity than the first antenna unit 1 and the second power supply unit 8 which extracts power from the radio wave received by the second antenna unit 7. In addition, the memory unit 6 includes the data memory unit 6C which stores data and the flag memory unit 6D which stores, flag values indicating data stored at the addresses in the data memory unit 6C need protection. Furthermore, the control unit 5 includes the access inhibition unit 5E which inhibits access from a communication device to a data storage area in the data memory unit 6C which is in protected state by a flag value in the flag memory unit 6D through the first antenna unit 1 if no power is received from the second power supply unit 8, and the access permission unit 5F which permits access from a communication device to a data storage area in the data memory unit 6C which is in protected state by a flag value in the flag memory unit 6D through the first antenna unit 1.

With this arrangement, when a communication device is located at a long distance from the RFID tag 103 (between the communicable distance of the first antenna unit 1 and the communicable distance of the second antenna unit 7), the first antenna unit 1 of the RFID tag 103 receives a radio wave from the communication device. This makes the first power supply unit 2 extract power from the radio wave received by the first antenna unit 1 and send the extracted power to the control unit 5. In this case, since the power of radio waves from the communication device is insufficient for the reception sensitivity of the second antenna unit 7, the second power supply unit 8 cannot extract power, and hence cannot send power (external power) to the control unit 5. This therefore inhibits access from a communication device to a data storage area in the data memory unit 6C which is in protected state through the first antenna unit 1, i.e., access from a communication device at a long distance to a data storage area in the data memory unit 6C in the RFID tag 103 which is in protected state. Note that this arrangement allows access from the communication device to a data storage area in the data memory unit 6C which is not in protected state through the first antenna unit 1, i.e., access from the communication device at a long distance to a data storage area in the data memory unit 6C in the RFID tag 103 which is not in protected state. This allows access from a long distance to data requiring no protection and can properly protect only data requiring protection against malicious access from a long distance. In the present invention, each data storage area in the data memory unit can be, for example, an address in the data memory unit 6C, a block comprising multiple addresses, or the like.

In contrast, when a communication device is located at a short distance from the RFID tag 103 (within the communicable distance of the second antenna unit 7), the power of radio waves from the communication device is sufficiently high for the reception sensitivity of the second antenna unit 7. This makes the first power supply unit 2 extract power from the radio wave received by the first antenna unit 1 and makes the second power supply unit 8 extract power from the radio wave received by the second antenna unit 7. The first and second antenna units then send the extracted power to the control unit 5. This therefore permits access from the communication device to a data storage area in the data memory unit 6C which is in protected state through the first antenna unit 1, and permits access from the communication device at a short distance to a data storage area in the data memory unit 6C in the RFID tag 103 which is in protected state, thereby allowing data write access and data read access to the data storage area set as a protection target. Even if some person has made malicious access, since such access must be made from a short distance, the user can easily visually check the access.

As described above, the present invention lets the RFID tag have the external power input unit 12, and controls permission and inhibition of access from a communication device to the memory unit 6 in accordance with the presence/absence of external power from the external power input unit 12. This makes it possible to prevent malicious access from a long distance by providing the second antenna unit 7 and the connection terminal 11 to the external power supply without physically removing part of an antenna.

In addition, the present invention controls permission and inhibition of access from a communication device to the protected memory unit 6A and access to a data storage area in the data memory unit 6C which is in protected state. This makes it possible to properly protect only data requiring protection against malicious access from a long distance and allow access from a long distance to data requiring no protection, thereby improving convenience.

What is claimed is:

1. An RFID tag characterized by comprising:
an external power input unit which inputs external power;
a first antenna unit which receives power from a communication device;
a first power supply unit which extracts power from the radio wave received by said first antenna unit;
a memory unit; and
a control unit which operates upon receiving power from said first power supply unit and controls permission and inhibition of access from the communication device to said memory unit in accordance with presence/absence of input of power from said external power input unit.

2. A tag according to claim 1, wherein said external power input unit inputs external power from a short distance shorter than a radio wave communicable distance of said first antenna unit.

3. A tag according to claim 1, wherein said
external power input unit comprises
a second antenna unit which has radio wave reception sensitivity lower than that of said first antenna unit, and
a second power supply unit which extracts power from the radio wave received by the second antenna unit.

4. A tag according to claim 3, wherein said
control unit comprises
an access inhibition unit which inhibits access from the communication device to said memory unit through said first antenna unit if no power is received from the second power supply unit, and
an access permission unit which permits access from the communication device to said memory unit through said first antenna unit if power is received from the second power supply unit.

5. A tag according to claim 3, wherein
said memory unit comprises a protected memory unit which stores data needing protection, and an unprotected memory unit which stores data needing no protection, and
said control unit comprises an access inhibition unit which inhibits access from the communication device to the protected memory unit if no power is received from the second power supply unit, and an access permission unit which permits access from the communication device to the protected memory unit through said first antenna unit if power is received from the second power supply unit.

6. A tag according to claim 3, wherein
said memory unit comprises a data memory unit which stores data, and a flag memory unit which stores a flag value indicating whether data stored at the addresses in the data memory unit need protection, and
said control unit comprises an access inhibition unit which inhibits access from the communication device to a data storage area in the data memory unit which is in protected state by a flag value in the flag memory unit through said first antenna unit if no power is received from the second power supply unit, and an access permission unit which permits access from the communication device to a data storage area in the data memory unit which is in protected state by a flag value in the flag memory unit through said first antenna unit if power is received from the second power supply unit.

7. A tag according to claim 3, wherein
said memory unit comprises a data memory unit which stores data, and a flag memory unit which stores a flag value indicating whether data stored at the addresses in the data memory unit need protection, and
said control unit comprises an access inhibition unit which inhibits access from the communication device to the flag memory unit through said first antenna unit if no power is received from the second power supply unit, and an access permission unit which permits access from the communication device to the flag memory unit through said antenna unit if power is received from the second power supply unit.

8. A tag according to claim 3, wherein
said memory unit comprises a protected memory unit which stores data needing protection, and an unprotected memory unit which stores data needing no protection, and
said control unit comprises an access inhibition unit which inhibits access from the communication device to the protected memory unit through said first antenna unit if no power is received from the second power supply unit, and an access permission unit which permits access from the communication device to the protected memory unit through the second antenna unit if power is received from the second power supply unit.

9. A tag according to claim 3, wherein
said memory unit comprises a data memory unit which stores data, and a flag memory unit which stores a flag value indicating whether data stored at the addresses in the data memory unit need protection, and
said control unit comprises an access inhibition unit which inhibits access from the communication device to a data storage area in the data memory unit which is in protected state by a flag value in the flag memory unit through said first antenna unit if no power is received from the second power supply unit, and an access permission unit which permits access from the communication device to a data storage area in the data memory unit which is in protected state by a flag value in the flag memory unit through the second antenna unit.

10. A tag according to claim 3, wherein said first
antenna unit and the second antenna unit use different frequency bands for communication.

11. A tag according to claim 10, wherein the second antenna unit receives a radio wave from a radio wave source different from the communication device.

12. A tag according to claim 1, wherein the
external power input unit comprises a connection terminal to an external power supply.

13. A tag according to claim 12, wherein said
control unit comprises
an access inhibition unit which inhibits access from the communication device to said memory unit through said first antenna unit if the external power supply does not connect to the connection terminal, and
an access permission unit which permits access from the communication device to said memory unit through said first antenna unit if the external power supply connects to the connection terminal.

14. A tag according to claim 12, wherein
said memory unit comprises a protected memory unit which stores data needing protection, and an unprotected memory unit which stores data needing no protection, and
said control unit comprises an access inhibition unit which inhibits access from the communication device to the protected memory unit through said first antenna unit if the external power supply does not connect to the connection terminal, and an access permission unit which permits access from the communication device to the protected memory unit through said first antenna unit if the external power supply connects to the connection terminal.

15. A tag according to claim 12, wherein
said memory unit comprises a data memory unit which stores data, and a flag memory unit which stores a flag value indicating whether data stored at the addresses in the data memory unit need protection, and
said control unit comprises an access inhibition unit which inhibits access from the communication device to a data storage area in the data memory unit which is in protected state by a flag value in the flag memory unit through said first antenna unit if the external power supply does not connect to the connection terminal, and an access permission unit which permits access from the communication device to a data storage area in the data memory unit which is in protected state by a flag value in the flag memory unit through said first antenna unit if the external power supply connects to the connection terminal.

16. A tag according to claim 12, wherein
said memory unit comprises a data memory unit which stores data, and a flag memory unit which stores a flag value indicating whether data stored at the addresses in the data memory unit need protection, and
said control unit comprises an access inhibition unit which inhibits access from the communication device to the flag memory unit through said first antenna unit if the external power supply does not connect to the connection terminal, and an access permission unit which permits access from the communication device to the flag memory unit through said first antenna unit if the external power supply connects to the connection terminal.
